(19) United States
(12) Patent Application Publication
(10) Pub. No.: US 2020/0254538 A1
(43) Pub. Date: Aug. 13, 2020

(54) END MILL INCLUDING FLAT RELIEF HAVING REINFORCED RIGIDITY

(71) Applicant: YG-1 Co., Ltd., Inceon (KR)

(72) Inventors: Young Koon Park, Incheon (KR); Hyung Suk KIM, Seoul (KR); Seung Hyun LEE, Gimpo-si (KR)

(73) Assignee: YG-1 Co., Ltd., Incheon (KR)

(21) Appl. No.: 16/656,011

(22) Filed: Oct. 17, 2019

(30) Foreign Application Priority Data
Feb. 8, 2019 (KR) 10-2019-0015213

(51) Int. Cl. B23C 5/10

(52) U.S. Cl. CPC B23C 5/10; B23C 2210/24; B23C 2210/54; B23C 2210/0407

(57) ABSTRACT

An end mill having an eccentric flat relief formed thereon is proposed. The eccentric flat relief (simply referred to as “ELF”) includes at least three flat relief surfaces continuously arranged along a trajectory of an eccentric relief. Accordingly, the end mill, which combines strengths of the flat relief and an eccentric relief, has excellent rigidity and a heat discharge characteristic.

### CROSS REFERENCE TO RELATED APPLICATION

The present application claims priority to Korean Patent Application No. 10-2019-0015213, filed Feb. 8, 2019, the entire contents of which is incorporated herein for all purposes by this reference.

### BACKGROUND OF THE INVENTION

### Field of the Invention

The present invention relates to an end mill for machining a heat resistant alloy (based on titanium and nickel), wherein strengths of a flat relief and an eccentric relief are combined.

### Description of the Related Art

An end mill as a rotary tool such as a drill includes a [symbol] least one cutting part having cutting teeth machined along a tool axis and a shank part extending from the cutting part. The cutting part includes a plurality of cutting teeth and flutes alternately arranged from a front end thereof to a peripheral surface thereof. The end mill is a widely used tool for metal precision machining, wherein side blades (outer peripheral blades) thereof are used to cut the peripheral surface of a workplace, and bottom blades thereof are used to cut an upper surface of the workpiece.

A space referred to as “relief” is provided in each of the side blades of the end mill to reduce friction between the cutting teeth and a workpiece by removing an outer circumferential surface of a rear of a cutting edge at a land thereof. A flat relief formed by machining a land into a flat surface; a concave relief formed by machining a land into a concave surface; and an eccentric relief formed by machining a land into a convex surface are widely used as a side blade relief. Particularly, the concave relief is a relief of a concave shape necessarily generated when a grinding wheel having an outer circumferential surface and machining a tool machines the flat relief, and all flat reliefs vary in degree but take forms of concave flats. Most flat reliefs are provided with one relief surface, but when a diameter of a tool is large, a secondary relief surface is also formed to be continued to a primary relief surface so as to secure more space.

A flat relief surface formed into a flat surface is easier to machine than an eccentric relief surface formed into a curved surface. In addition, a cutting tooth having the flat relief is more slender and sharper than a cutting tooth having the eccentric relief, which is a curved surface, thereby having an excellent machinability. In addition, the above-mentioned flat relief provides a relatively wider space between a workpiece and cutting teeth than the eccentric relief, so the flat relief has a better heat discharge performance than the eccentric relief. On the contrary, the eccentric relief is convexly manufactured and thus cutting teeth thereof are thick. Accordingly, the eccentric relief has higher rigidity and a longer life than the flat relief. Since the end mill is a consumable, the eccentric relief having higher rigidity and a longer life than the flat relief is widely used in the industry.

Recently, the use of a high temperature alloy is increasing in various fields including aerospace. In the cutting of workpieces of the high temperature alloy, heat distribution and heat discharge of an end mill have more influence on life of the end mill than rigidity thereof. Accordingly, the flat relief, which has a better heat discharge performance in a side blade than the eccentric relief, is more advantageous in machining the high temperature alloy than the eccentric relief. When the side blade of the end mill wears off during cutting, a contact area of the eccentric relief thereof with a workpiece becomes wider, so a heat discharge performance of the end mill deteriorates. Still, the flat relief is not absolutely advantageous since weakness of the flat relief having low rigidity of the side blade still holds true even in the high temperature alloy processing.

### SUMMARY OF THE INVENTION

Accordingly, the present invention has been made keeping in mind the above problems occurring in the related art, and the present invention is intended to propose an end mill, which combines strengths of a flat relief and an eccentric relief, having excellent rigidity and a heat discharge characteristic.

Considering that the flat relief is better in a heat discharge characteristic than the eccentric relief and a tool having the eccentric relief still has excellent rigidity, the present invention is intended to propose an end mill for a heat resistant alloy which has improved heat discharge performance and maintains excellent rigidity.

In order to achieve the above objective, according to one aspect of the present invention, there is provided an end mill including: a cutting part having a plurality of bottom blades at a front end thereof and a plurality of side blades at a peripheral surface thereof; and a shank part extended from the cutting part along a central axis of the cutting part in a longitudinal direction thereof, wherein an Eccentric Flat (ELF) relief surface is provided in a land of at least one side blade of the plurality of side blades, the eccentric flat relief surface having at least three consecutive flat relief surfaces extending from a cutting edge. Meanwhile, the flat relief is machined by a circular grinding wheel, so although a flat surface is machined by any large wheel, the flat surface may become a concave surface within a predetermined error range. When this is considered, at least three flat reliefs of the present invention that constitute an eccentric flat relief may include concave surfaces or concave reliefs realized due to machining tolerances during flat machining.

For example, the eccentric flat relief surface may be embodied to include three flat relief surfaces that have a first flat relief surface forming the cutting edge together with a rake surface, a second flat relief surface extending from the first flat relief surface, and a third flat relief surface extending from the second flat relief surface.

Furthermore, the eccentric flat relief surface preferably may follow a trajectory of a conventional eccentric relief. For example, a relief angle obtained on the said at least three flat relief surfaces may preferably be 5° to 20°. The relief angle may be obtained by arctangent of a maximum drop compared to a shortest distance of the said at least three flat relief surfaces. Relative to a cross section perpendicular to the central axis, the maximum drop may be a maximum distance in a normal direction from a virtual outer circumferential surface defined by the cutting edge to the said at least three flat relief surfaces.

The end mill according to the present invention includes “the eccentric flat relief surface” (ELF surface) having the at least three consecutive flat relief surfaces arranged along a trajectory of the eccentric relief.

“The eccentric flat relief” is provided by repeatedly having a flat relief surface formed into a flat surface, and accordingly, has excellent workability of a conventional flat relief and maintains machinability and heat discharge performance more excellent than a conventional eccentric relief. On the other hand, the eccentric flat relief is arranged along the trajectory of the eccentric relief and has cutting tooth thicker than cutting tooth of the conventional flat relief. Accordingly, the eccentric flat relief is excellent in rigidity.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a view illustrating an end mill according to an embodiment of the present invention;

FIG. 2 is a view illustrating a front surface of the end mill according to the embodiment of the present invention;

FIG. 3 is a view illustrating an eccentric flat relief according to the embodiment of the present invention;

FIG. 4 illustrates images in which cutting edges of the end mill of the present invention and a comparison end mill after side cutting are taken; and

FIG. 5 illustrates images in which cutting edges of the end mill of the present invention and the comparison end mill after slotting are taken.

### DETAILED DESCRIPTION OF THE INVENTION

Hereinafter, the present invention will be described in more detail with reference to the accompanying drawings.

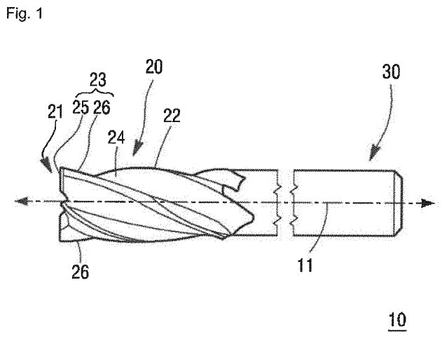

Referring to FIG. 1, an end mill according to the present invention 10 includes a cutting part 20 formed along a central axis 11 and a shank part 30 provided at a rear end of the cutting part 20. Although the end mill 10 of FIG. 1 is an end mill of a normal solid type, the end mill is not limited thereto and various types of end mills such as a dividing head type or a brazing type may be used.

As illustrated in FIG. 1, the end mill 10 is a square end mill, wherein a front end 21 of the cutting part 20 thereof is flat, but any conventional end mill may be used as the end mill. For example, the end mill of the present invention may be applied to a ball (Ball nose) type, a taper type, and a tapered ball type classified according to a front end of the cutting part 20. Furthermore, the shank part 30 may also be manufactured into any type shank of a straight shank, a flat shank, a combination shank, or a taper shank. Furthermore, the end mill of the present invention may be applied even to a tool having a plurality of cutting parts arranged on a shank.

The cutting part 20 includes a plurality of cutting teeth 23 and flutes 24 alternately arranged from the front end 21 to a peripheral surface 22. Each of the cutting teeth 23 includes a bottom blade 25 provided at the front end 21 and a side blade 26 formed on the peripheral surface 22 by extending from the bottom blade 25, and is spirally arranged along a core of the cutting part 20. Here, the end mill 10 of the present invention is required to have a plurality of side blades 26.

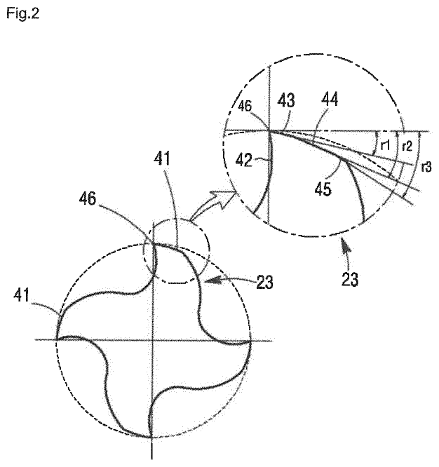

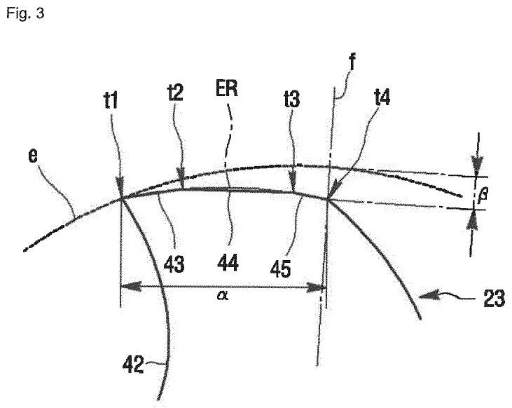

Referring to FIGS. 2 and 3, in the end mill 10 of the present invention, at least three consecutive flat relief surfaces extending from a cutting edge 46 are arranged in a land 41 of at least one side blade 26 of the plurality of side blades along a trajectory of an eccentric relief. Accordingly, the at least three flat relief surfaces are required to be arranged along a circular arc placed on the same radius from a virtual center point eccentric from the central axis 11. Hereinbelow, the at least three flat relief surfaces, which are arranged to be continued to each other along a trajectory of the eccentric relief, are referred to as “the eccentric flat relief” (simply referred to as “ELF”). Meanwhile, the flat relief is machined by a circular grinding wheel, so although a flat surface is machined by any large wheel, the flat surface may become a concave surface within a predetermined error range. When this is considered, the at least three flat reliefs that constitute an eccentric flat relief may include a concave surface or a concave relief realized due to machining tolerances during flat machining.

“The eccentric flat relief” is provided by repeatedly having a flat relief surface formed into a flat surface, and accordingly, has excellent workability of a conventional flat relief and maintains machinability and a heat discharge performance more excellent than a conventional eccentric relief. On the other hand, the eccentric flat relief is arranged along the trajectory of the eccentric relief and has a cutting tooth thicker than cutting tooth of the conventional flat relief. Accordingly, the eccentric flat relief is excellent in rigidity.

Each of cutting teeth 23 illustrated in FIG. 2 is an example in which the eccentric flat relief having the three flat relief surfaces is provided in the land 41, and an eccentric flat relief surface includes a first flat relief surface 43 forming the cutting edge 46 together with a rake surface 42, a second flat relief surface 44 extending from the first flat relief surface 43, and a third flat relief surface 45 extending from the second flat relief surface 44. As illustrated in FIG. 3, a virtual trajectory ER of the eccentric relief is the circular arc connecting two ends t1 and t4 of the land 41 to each other as viewed from a cross section perpendicular to the central axis 11. The first to the third flat relief surfaces 43, 44, and 45 are required to follow the trajectory of one eccentric relief. Accordingly, opposite ends t1 and t2 of the first flat relief surface 43, opposite ends t2 and t3 of the second flat relief surface 44, and opposite ends t3 and t4 of the third flat relief surface 45 are arranged on the virtual trajectory ER of the eccentric relief.

When it is considered that the eccentric relief is designed to have a relief angle of 5° to 20°, the eccentric flat relief also has preferably a relief angle of 5° to 20°. The relief angle of the eccentric flat relief of the present invention is obtained by the following equation 1.

$$EFL Angle = {tan}^{- 1} ( \frac{β}{α} ) \qquad [ Equation 1 ]$$

Here, α is a shortest distance of the eccentric flat relief, that is, a shortest distance of the opposite ends of the land 41. β is a maximum drop between the eccentric flat relief surface and an outer circumferential surface e, and is measured on a normal perpendicular to the outer circumferential surface (or a central line f passing the central axis).

Experiment Result

To test performance of the eccentric flat relief of the present invention, \textcircled{1} the end mill of the present invention having the eccentric flat relief and \textcircled{2} a comparison end mill having the eccentric relief for comparison are prepared, wherein work materials made of the same alloy are processed in the same machining method.

The test was performed by using the end mill having an outer diameter of Ø10 mm, and a super heat-resistant alloy Inconel 718 (a nickel alloy) was used as a work material. Processing methods applied to the test include slotting in which slots are processed by using the side and bottom blades, and side cutting in which a peripheral surface of a work material is processed by using the side blade, and cutting oil was used for cooling in the slotting and the side cutting. Each cutting condition is shown in the following Table 1.

TABLE 1

| | | | |
|---|---|---|---|
| Cutting condition | Slotting | RPM | 796 |
| | | FEED | 96 |
| | | Ae | 1.0 × D |
| | | Ap | 0.6 × D |
| Cutting condition | Side Cutting | RPM | 1019 |
| | | FEED | 130 |
| | | Ae | 0.30 × D |
| | | Ap | 0.80 × D |

| | |
|---|---|
| Type of Tool Holder | Milling Chuck, BT 50 |
| Work Material | Inconel [Inconel 718 HRc 39] |
| Cooling method | Wet Cut (water soluble) 9% |

In Table 1, Ae refers to a radial depth, Ap refers to an axial depth, and D refers to an outer diameter of the end mill. Accordingly, in the present test, the super heat-resistant alloy Inconel 718 is machined by the end mill having an outer diameter of 10 mm, wherein the super heat-resistant alloy has a radial depth 3 mm and an axial depth 8 mm processed by the side cutting, and a radial depth 10 mm and an axial depth 6 mm processed by the slotting.

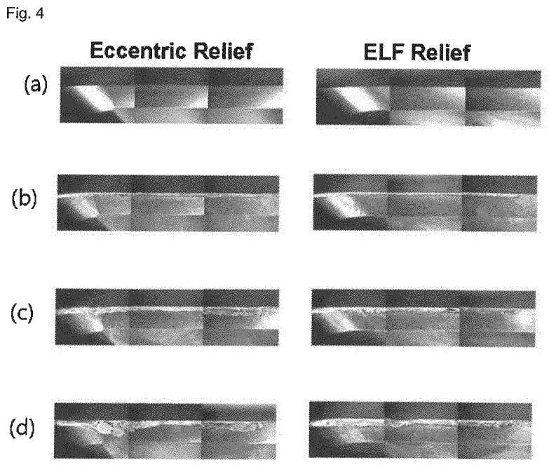

FIG. 4 illustrates (a) images of cutting edges of the end mill of the present invention and the comparison end mill taken before the test, (b) images of the cutting edges of the end mills taken after having a cutting length 1.6 m formed by the side cutting, (c) images of the cutting edges thereof taken after having a cutting length 4.8 m formed by the side cutting, and (d) images of the cutting edges thereof taken after having a cutting length 6.4 m formed by the side cutting.

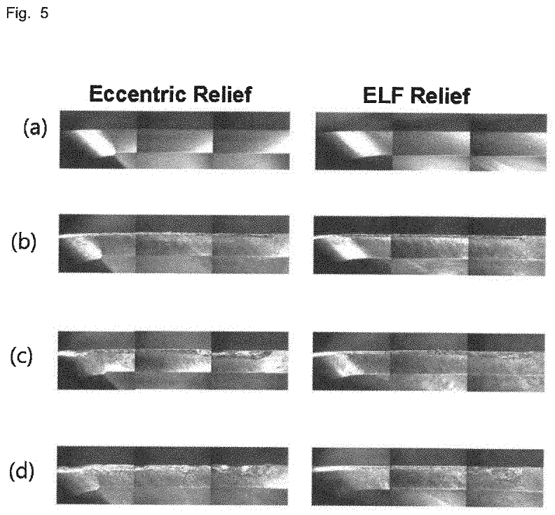

FIG. 5 illustrates (a) images of cutting edges of the end mill of the present invention and the comparison end mill taken before the test, (b) images of the cutting edges of the end mills taken after having a cutting length 0.8 m formed by the slotting, (c) images of the cutting edges thereof taken after having a cutting length 2.4 m formed by the slotting, and (d) images of the cutting edges thereof taken after having a cutting length 4 m formed by the slotting.

Referring to FIGS. 4 and 5, when the same work material is processed in the same process condition, the cutting edge of the end mill of the present invention is considerably less damaged than the cutting edge of the comparison end mill having the eccentric relief.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An end mill for a heat-resistant alloy, the end mill comprising:
a cutting part having a plurality of bottom blades at a front end thereof and a plurality of side blades at a peripheral surface thereof; and
a shank part extended from the cutting part along a central axis of the cutting part in a longitudinal direction thereof,
wherein an eccentric flat relief surface is provided in a land of at least one side blade of the plurality of side blades, the eccentric flat relief surface having at least three consecutive flat relief surfaces extending from a cutting edge, and
wherein a relief angle of the eccentric flat relief obtained by taking arctangent of the ratio of a shortest distance of the eccentric flat relief surface to a maximum drop in a normal direction to the eccentric flat relief surface from a virtual outer circumferential surface defined by the cutting edge is 5° to 20°.

2. The end mill of claim 1, wherein opposite ends of each of the at least three flat relief surfaces are arranged on a virtual circular arc connecting the opposite ends of the land to each other relative to the cross section perpendicular to the central axis, and
the circular arc has a virtual center point eccentric from the central axis.

3. The end mill of claim 1, wherein the eccentric flat relief surface comprises:
a first flat relief surface forming the cutting edge together with a rake surface;
a second flat relief surface extending from the first flat relief surface; and
a third flat relief surface extending from the second flat relief surface.
